(19) United States
(12) Patent Application Publication
(10) Pub. No.: US 2026/0316081 A1
(43) Pub. Date: Oct. 15, 2026

(54) VACUUM FILTER SYSTEM

(71) Applicant: HANS-WERNER HEINRICH, LUDWIGSFELDE (DE)

(72) Inventor: HANS-WERNER HEINRICH, LUDWIGSFELDE (DE)

(21) Appl. No.: 19/562,811

(22) Filed: Mar. 11, 2026

(30) Foreign Application Priority Data
Mar. 12, 2025 (DE) 10 2025 109 427.6
Mar. 3, 2026 (DE) 10 2026 108 529.6

(51) Int. Cl. B01L 3/00

(52) U.S. Cl. CPC B01L 3/50825; B01L 2200/0631; B01L 2200/0689; B01L 2300/042; B01L 2300/0681; B01L 2300/14

(57) ABSTRACT

A system for filtering a liquid. The system includes a collecting vessel and an elastic plug-like device. The elastic plug-like device has a first volume having a first opening, a second volume having a second opening and a filter which is disposed at the second opening, and a separating wall formed between the first volume and the second volume. The first opening is arranged to accommodate insertion of a pipette tip. The separating wall has at least one perforation and a gas barrier layer which is made of an aluminum-composite material. The gas barrier layer separates the second volume from the first volume in a gas-impermeable manner.

### CROSS REFERENCE TO PRIOR APPLICATIONS

Priority is claimed to German Patent Application No. DE 10 2025 109 427.6, filed Mar. 12, 2025 and to German Patent Application No. DE 10 2026 108 529.6, filed Mar. 3, 2026. The entire disclosure of said applications are incorporated by reference herein.

### FIELD

The present invention relates to a system for filtering small amounts of liquid, in which a vacuum is provided, and to a method for filtering liquids using the system.

### BACKGROUND

Devices for filtering small amounts of liquid are known conventionally in syringes with filters and cell strainers. Pipettes are typically used to transport liquids in a laboratory. This involves the aspiration of corresponding liquid samples into the pipette and their transfer into a fitting comprising a filter or strainer. Small amounts of liquid are defined here as volumes in the range from 1 μl to 10 ml, in particular in the range from 10 μl to 1 ml.

A risk of contamination of the surrounding area exists through inadvertent distribution of liquid material in devices such as pipettes and filters when handling infectious material. Related devices are also usually thoroughly packed, so that time is required to remove the devices from the packaging material, which packaging material must be disposed of. It is therefore desirable to accelerate a filtering process.

### SUMMARY

An aspect of the present invention is to improve the speed and safety of filtration processes as well as to reduce packaging material.

In an embodiment, the present invention provides a system for filtering a liquid. The system includes a collecting vessel and an elastic plug-like device. The elastic plug-like device comprises a first volume comprising a first opening, a second volume comprising a second opening and a filter which is disposed at the second opening, and a separating wall formed between the first volume and the second volume. The first opening is arranged to accommodate insertion of a pipette tip. The separating wall comprises at least one perforation and a gas barrier layer which is made of an aluminum-composite material. The gas barrier layer is configured to separate the second volume from the first volume in a gas-impermeable manner.

### BRIEF DESCRIPTION OF THE DRAWINGS

The present invention is described in greater detail below on the basis of embodiments and of the drawings in which:

FIG. 1 shows a schematic representation of an embodiment of a system according to the present invention;

FIG. 2 shows a schematic representation of an embodiment of a plug-like device of the system according to FIG. 1;

FIG. 3 shows the system according to FIG. 1 with a pipette tip; and

FIG. 4 shows a flowchart of an embodiment of the method according to the present invention.

### DETAILED DESCRIPTION

A first aspect of the present invention relates to a system for filtering liquids comprising an elastic plug-like device and a collecting vessel, wherein the device comprises at least a first volume having a first opening and at least a second volume having a second opening, the opening of the first volume is designed to accommodate a pipette tip to be inserted, the second volume has a filter arranged in the region of the second opening, and a separating wall with at least one perforation is provided between the first volume and the second volume, the separating wall having gas barrier layer which is made of an aluminum composite and which separates the second volume from the first volume in a gas-impermeable manner.

The present invention advantageously permits a safe and rapid filtering process. The separating wall, which can also be designated as a septum, in particular allows a reduced pressure to be applied in the second volume. Opening the separating wall allows the reduced pressure to be exerted on a liquid. When the separating wall is pierced by a pipette tip, this allows a liquid to be aspirated from the pipette through the filter, thereby significantly accelerating the filtration process compared to a positive pressure normally used to push a liquid from a pipette into a filter device and then slowly through the filter into a collecting vessel by gravity.

The system according to the present invention is particularly suitable for filtering any biological or chemical liquids selected from the group comprising body fluids, cell and cell culture suspensions, blood, serum, plasma and chemical reagents.

The gas barrier layer made of an aluminum composite is arranged on the outside of the device, i.e., opposite to the volume of the collecting vessel. The gas barrier layer can be glued to the outside. The gas barrier layer advantageously enhances the separation effect. The perforation facilitates a convenient piercing of the separating wall by a pipette tip.

The aluminum composite comprises an aluminum foil which is 10 to 40 μm thick and has a polymer coating on one side or on both sides. Polymers used are in particular PET, LDPD and PA. The polymer material is permanently bound to surface of the device by way of heat and pressure.

The elastic plug-like device is designed as a closure for the collecting vessel. This can, for example, allow the opening of the collecting vessel to be closed airtight by the device. No air can thus advantageously enter the collecting vessel. The material of the device is in particular an isobutylene-isoprene copolymer or an ethylene-propylene-diene rubber. The elastic form provides for the airtight closure of the opening of the collecting vessel because the device is stretched airtight to the vessel via a reduced pressure in the vessel. This advantageously enables the maintenance of a reduced pressure in the collecting vessel at a desired level by preventing air from entering.

An appropriate reduced pressure/vacuum can be provided in a collecting vessel by evacuating the collecting vessel in a vacuum chamber and, for example, evacuating with a rubber closure. The collecting vessel is thus evacuable. The collecting vessel of the system can, for example, have a reduced pressure. Appropriate collecting vessels are commercially available, for example, in the form of blood collection tubes. The reduced pressure provides the advantageous effect for the system that a sample can be sucked directly through the filter into the collecting vessel. In contrast thereto, conventional systems require a force to transfer a sample through the filter into the collecting vessel which must be applied manually or by auxiliary means (for example, via a thumb on a pipette, pumps or centrifuges). A fast and effective filtration process is thereby provided by a pressure differential between a reduced pressure in the collecting vessel and atmospheric pressure.

The separating wall of the plug-like device can, for example, be formed in a thickness of between 0.1 and 2.0 mm. The gas barrier layer can, for example, be formed in a thickness of about 20 μm. The thickness of the gas barrier layer can thereby vary by about 10 μm. The separating wall is perforated and can thus be pierced by a pipette tip with a modest level of force. Pipette tips are pointed at the bottom and are usually made of a hard plastic material so that an elastic, rubbery material can easily be pierced.

The filter can, for example, have a pore size in the range of between 10 nm and 10 μm. Filters having a suitable pore size can be provided depending on the material and on the particles, cells or molecules to be filtered.

In an embodiment of the present invention, the device can, for example, be formed in two parts. A first part comprises the device having the first and second volume, and a second part comprises the filter, which is produced separately and which is attached to the first part before the device is inserted into a collecting vessel.

Functionalized particles can, for example, also be arranged in the second volume. Functionalized particles in particular have surface structures that can interact with certain particles, molecules or cells so that they can be selectively removed from the liquid to be filtered. This makes it possible for the filtrate to be advantageously purified of certain substances.

The collecting vessel can, for example, have a screw cap. This allows the collecting vessel with the device to be additionally sealed from the surrounding area.

The collecting vessel and the screw cap can, for example, comprise a flexible material which is selected from the group comprising isobutylene-isoprene copolymers or ethylene-propylene-diene rubber, polyvinyl chloride, polypropylene or polyethylene terephthalate.

A second aspect of the present invention relates to a method for filtering a liquid using a system according to the present invention, the method comprising the following steps:
arranging the device in the collecting vessel;
evacuating the collecting vessel;
inserting a pipette with a pipette tip containing the liquid to be filtered into the opening of the first volume of the device;
piercing the separating wall of the device through the pipette tip;
transferring the liquid from the pipette into the second volume of the device via reduced pressure; and
collecting the liquid in the collecting vessel.

The advantages of the method correspond to the advantages of the device according to the present invention.

The method can, for example, include the introduction of functionalized particles into the second volume.

The present invention is explained in greater detail below with reference to the drawings.

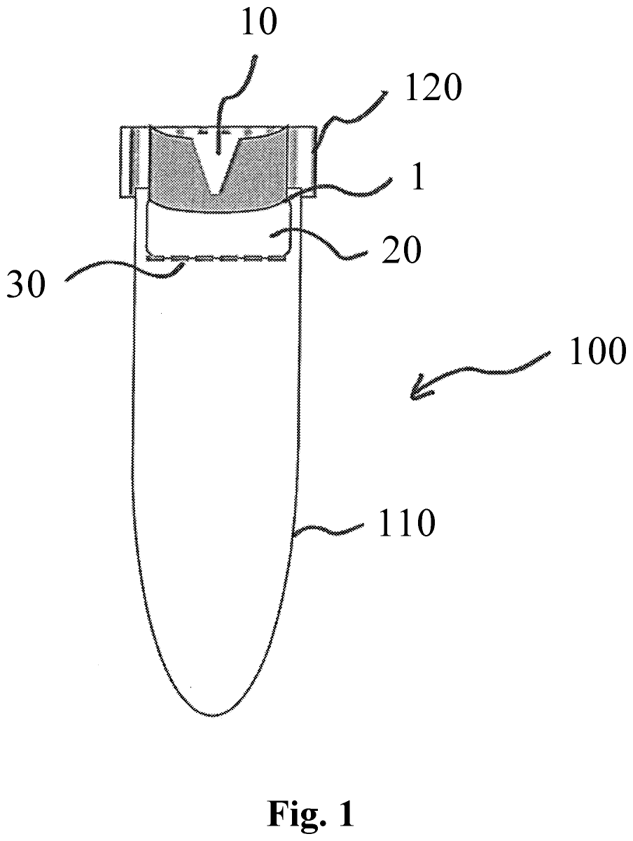

An embodiment of a system 100 according to the present invention as shown in the sectional representation in FIG. 1 comprises a plug-like device 1 and a collecting vessel 110. The device 1 is inserted into the collecting vessel 100. The collecting vessel 110 can be closed with a screw cap 120 above the inserted device 1.

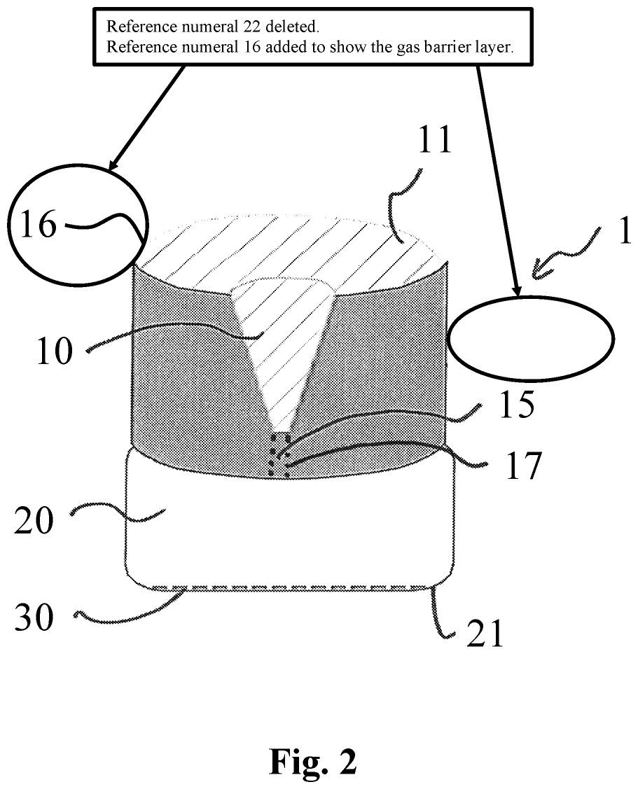

The device 1 is provided for filtering a liquid. The device 1 is shown in a larger view in FIG. 2. The device 1 comprises a first volume 10 and a second volume 20.

The material of the device 1 is, for example, an isobutylene-isoprene copolymer. The device 1 may alternatively also comprise ethylene-propylene-diene rubber or a further suitable elastic polymer. The material of the collecting vessel 110 and of the screw cap 120 is, for example, polypropylene. The material of the collecting vessel 110 and of the screw cap 120 may also comprise polyvinyl chloride, polyethylene terephthalate or another suitable material.

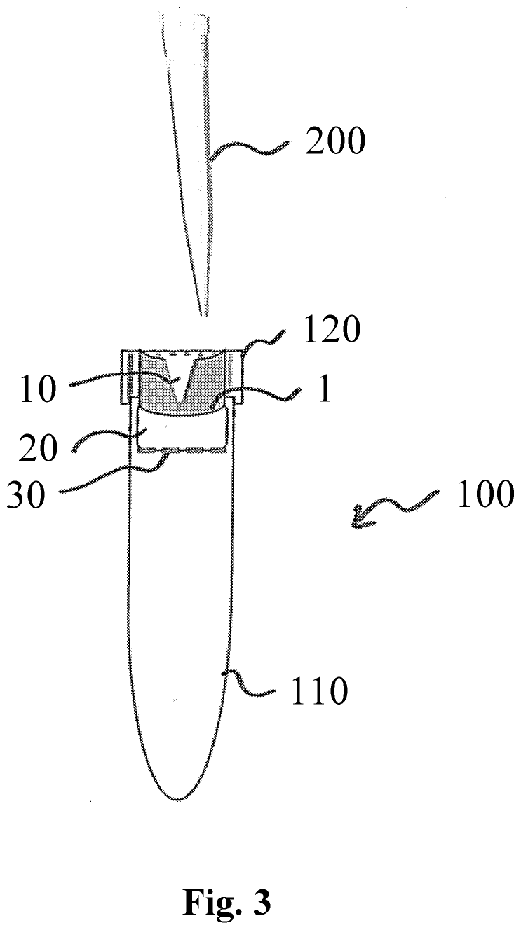

The first volume 10 is tailored in its shape and size to a pipette tip 200 that is to be used (see FIG. 3). The opening of the first volume 10 to the top 11 of the device 1 is here round in shape, with the circumference of the first volume 10 decreasing in the direction of the second volume 20. The volume of the first volume 10 is here 10 μl to 100 μl, for example, 20 μl, in accordance with the pipette tip to be used. The volume of the second volume 20 is tailored to the amount of liquid to be filtered with which it is filled and is 100 μl to 1000 μl, for example, 500 μl.

A separating wall 15 is provided between the first volume 10 and the second volume 20. The separating wall 15 is made of the material of the device 1 and separates the first volume 10 from the second volume 20 in an airtight manner. At the top 11, i.e., opposite to the volume of the collecting vessel 110, a gas barrier layer 16 is arranged which is indicated by a hatching of the top 11 (see FIG. 2). The gas barrier layer 16 covers the top 11 including the first volume 10.

The separating wall 15 has a thickness of 0.5 mm. The separating wall 15 may alternatively have other thicknesses in the range from 0.1 to 2 mm. The separating wall 15 comprises a perforation 17 which is indicated by a dotted line.

The gas barrier layer 16 has a thickness of 20 μm. The gas barrier layer 16 comprises an aluminum foil which has a polymer coating of polyethylene terephthalate (PET) on both sides.

The second volume 20 is larger and is provided for accommodating a liquid. A filter 30 is arranged for filtering the liquid in the region of the bottom 21. The filter 30 has, for example, a pore size of 10 μm. The pores may alternatively have a size in the range between 10 nm and 10 μm. Devices 1 are provided with filters 30 of suitable pore size depending on a planned application, i.e., in relation to the material expected to be filtered.

Functionalized particles having particular surface structures can be introduced into the second volume 20. Certain surface structures are particularly suitable for interacting with particular particles, molecules or cells in order to selectively remove them from the liquid to be filtered.

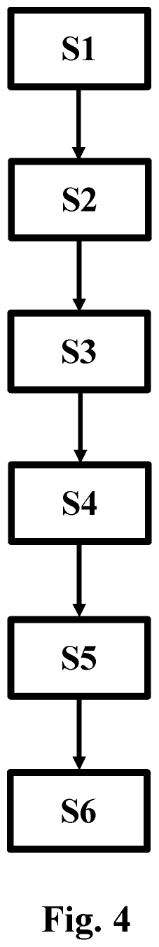

In a method for filtering a liquid via a system 100 according to the flow diagram shown in FIG. 4, a device 1 is arranged in a collecting vessel 110 in a first step S1. In Step S2, the collecting vessel 110 is evacuated so that there is an approximate vacuum in the collecting vessel 110, at least a clear reduction in pressure between the collecting vessel 110 and the surrounding area.

In a third step S3, a pipette with a pipette tip 200 containing the liquid to be filtered is inserted into the opening of the first volume 10 of the device 1 (see FIG. 3). In a fourth step S4, the separating wall 15 of the device 1 is pierced by the pipette tip 200.

In a fifth step S5, the reduced pressure in the collecting vessel draws liquid from the pipette into the second volume of the device. The liquid runs further through the filter 30 and is collected in the collecting vessel 110 in a sixth step S6.

The present invention is not limited to embodiments described herein; reference should be had to the appended claims. Further advantageous embodiments and configurations of the present invention result from the subclaims, the drawings and the working examples. The embodiments of the present invention can also advantageously be combined.

LIST OF REFERENCE NUMERALS

| | |
|---|---|
| 1 | Device |
| 10 | First volume |
| 11 | Top |
| 15 | Separating wall |
| 16 | Gas barrier layer |
| 17 | Perforation |
| 20 | Second volume |
| 21 | Bottom |
| 30 | Filter |
| 100 | System |
| 110 | Collecting vessel |
| 120 | Screw cap |
| 200 | Pipette tip |

1-11. (canceled)

12: A system for filtering a liquid, the system comprising:
a collecting vessel; and
an elastic plug-like device,
wherein the elastic plug-like device comprises:
a first volume comprising a first opening, the first opening being arranged to accommodate insertion of a pipette tip;
a second volume comprising a second opening and a filter which is disposed at the second opening; and
a separating wall formed between the first volume and the second volume, the separating wall comprising at least one perforation and a gas barrier layer which is made of an aluminum-composite material, the gas barrier layer being configured to separate the second volume from the first volume in a gas-impermeable manner.

13: The system as recited in claim 12, wherein
the collecting vessel comprises an opening, and
the elastic plug-like device is configured to close the opening of the collecting vessel in an airtight manner.

14: The system as recited in claim 13, wherein the collecting vessel is configured to maintain a reduced pressure.

15: The system as recited in claim 12, wherein the separating wall has a thickness of between 0.1 and 2.0 mm.

16: The system as recited in claim 12, wherein the gas barrier layer has a thickness of about 20 μm.

17: The system as recited in claim 12, wherein the filter has a pore size of between 10 nm and 10 μm.

18: The system as recited in claim 12, wherein
a first part comprises the first volume and the second volume,
a second part comprises the filter, and
the second part is configured to be produced separately from the first part and to be attached to the first part before the elastic plug-like device is inserted into a collecting vessel.

19: The system as recited in claim 12, wherein the second volume comprises functionalized particles disposed therein.

20: The system as recited in claim 12, wherein the collecting vessel comprises a screw cap.

21: The system as recited in claim 20, wherein the collecting vessel and the screw cap each comprise a flexible material comprising at least one compound selected from isobutylene-isoprene copolymers, ethylene-propylene-diene rubber, polyvinyl chloride, polypropylene, and polyethylene terephthalate.

22: A method for filtering a liquid via the system as recited in claim 12, the method comprising:
arranging the elastic plug-like device in the collecting vessel;
evacuating the collecting vessel;
inserting a pipette comprising a pipette tip and containing the liquid to be filtered into the first opening of the first volume of the elastic plug-like device;
piercing, via the pipette tip, the separating wall of the elastic plug-like device thereby establishing a direct connection between the second volume of the elastic plug-like device and the pipette tip; and
transferring the liquid from the pipette via the filter of the elastic plug-like device into the collecting vessel via a pressure differential existing between the collecting vessel and the pipette tip.
